(19) United States
(12) Patent Application Publication
(10) Pub. No.: US 2013/0128590 A1
(43) Pub. Date: May 23, 2013

(54) LED UNIT

(71) Applicant: HSIU-PING CHANG, Chu-Nan (TW)

(72) Inventor: HSIU-PING CHANG, Chu-Nan (TW)

(73) Assignee: FOXSEMICON INTEGRATED TECHNOLOGY, INC., Chu-Nan (TW)

(21) Appl. No.: 13/300,730

(22) Filed: Nov. 21, 2011

(51) Int. Cl. F21V 5/04; F21V 7/00

(52) U.S. Cl. 362/296.01; 362/311.02; 362/327

(57) ABSTRACT

A light emitting diode (LED) unit having a lens producing parallel light beams is disclosed. The LED unit comprises an LED; and a lens comprising a light incident face facing the LED, a light emergent face away from the LED, and a light reflecting face between the light incident face and the light emergent face; the light incident face comprises a first light incident face over the LED, and a second light incident face encircling the LED; and the light emergent face comprises a first light emergent face corresponding to the first light incident face, and a second light emergent face corresponding to the second light incident face, wherein the first light emergent face, relative to the first light incident face, is lower than the second light emergent face.

### BACKGROUND

1. Technical Field

The present disclosure relates to a light emitting diode (LED) unit and, more particularly, to an LED unit having a lens producing parallel light beams.

2. Description of Related Art

Light emitting diodes (LEDs) became available since the early 1960's, and because of their high light-emitting efficiency, have been increasingly used in a wide variety of applications in residential, traffic, commercial, and industrial locations. Conventionally, light directly output from the LED does not have a desirable pattern; therefore, a light-adjusting element, such as a lens, is used with the LED to modulate the light pattern thereof.

However, a typical lens generally has a limited light-converging capability; that is, light passing through the lens may not be effectively converged to a narrow beam. As a result, light radiated from a typical lens may not travel long distances because of the spreading of the light beams.

Therefore, an improved LED unit is needed to overcome the disadvantages described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a lens of an LED unit in accordance with an embodiment of the present disclosure.

FIG. 2 shows a cross sectional view of the LED unit with the lens of FIG. 1 mounted on an LED module.

### DETAILED DESCRIPTION OF THE EMBODIMENTS

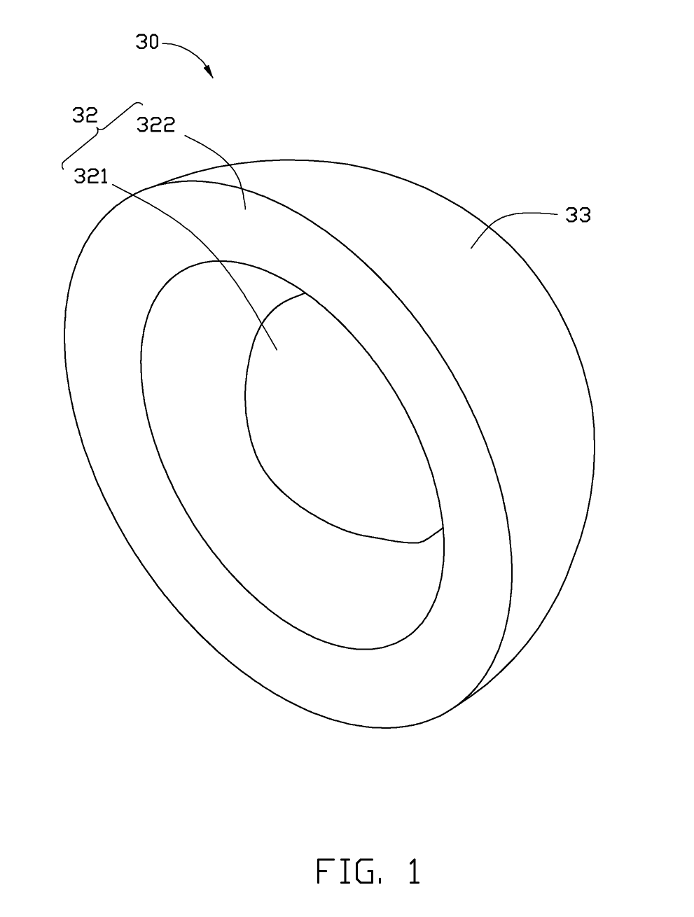

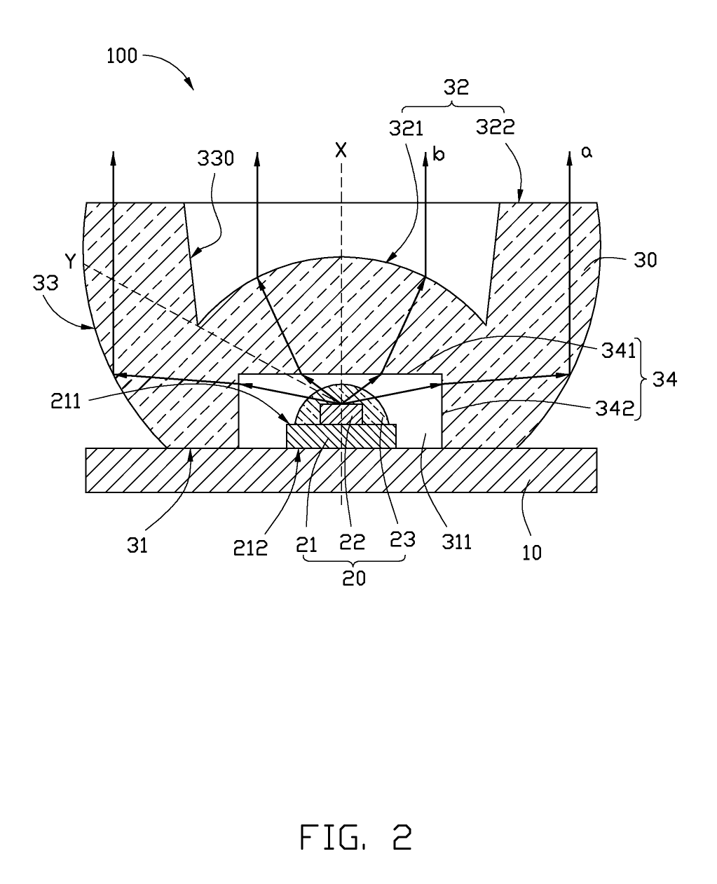

Referring to FIGS. 1 and 2, an LED unit 100 in accordance with an embodiment of the present disclosure is illustrated. The LED unit 100 includes an LED module and a lens 30 mounted on the LED module. The LED module includes a printed circuit board 10 and an LED (light emitting diode) 20 mounted on the printed circuit board 10. The printed circuit board 10 may be a MCPCB (Metal Core Printed Circuit Board), a CPCB (Ceramic Printed Circuit Board) or other types of printed circuit boards with good heat dissipation capabilities. The LED 20 includes a heat-conducting base 21, an LED die 22 mounted on a top face of the heat-conducting base 21, and an encapsulant 23 covering the LED die 22 and fixed to the top face 211 of the heat-conducting base 21. A bottom face 212 of the heat conducting base 21 of the LED 20 may be soldered on the printed circuit board 10 to conduct heat generated by the LED die 22 to the printed circuit board 10. In addition, the LED die 22 is electrically connected with the printed circuit board 10 via the heat-conducting base 21. The LED die 22 may be an InGaN chip, a GaN chip, an AlInGaN chip, an InGaAs chip, a GaP chip or other suitable chips capable of generating visible light with a desirable color. The encapsulant 23 is made of epoxy, silicon, glass or other transparent materials with have good light-permeable and water-proof capabilities. Phosphor, often in the form of particulates, may be doped within the encapsulant 23 to adjust colors of the light emitted from the LED die 22. The encapsulant 23 is shaped like a dome so as to collimate light emitted from the LED die 22 into a converged beam. The encapsulant 23 is spaced from the lens 30. The LED 20 has an optical axis X, around which the light emitted from the encapsulant 23 is symmetrical in a surrounding space.

Referring to FIG. 2, the lens 30 may be made from transparent materials such as PC (polycarbonate) or PMMA (polymethyl methacrylate). The lens 30 is bowl shaped with a top face and a bottom face 31. Glue (not shown) may be smeared on the bottom face 31 of the lens 30 to fix the lens 30 onto the printed circuit board 10. A cavity 311 is defined in an interior of the lens 30. The cavity 311 is open in the bottom face 31 of the lens 30 to receive the LED 20 therein. The cavity 311 has a shape of a column. An inner face of the lens 30 over and facing the LED 20 (i.e., a top face of the cavity 311) may function as a first light-incident face 341 of the lens 30 to receive light emitted from the LED 20 with a small light-emergent angle (such the light beam b shown in FIG. 2). Another inner surface of the lens 30 surrounding the LED 20 (i.e., a circumferential face of the cavity 311) may function as a second light-incident face 342 of the lens 30 to receive light emitted from the LED 20 with a large light-emergent angle (such as the light beam a shown in FIG. 2). The first light-incident face 341 is planar, and the second light-incident face 342 is annular with a constant curvature. The first light-incident face 341 and the second light-incident face 342 cooperatively form a light-incident face 34 to refract all of the light emitted from the LED 20 into the lens 30.

An outer circumference of the lens 30 may function as a light-reflecting face 33 to totally reflect the light transferred from the second light-incident face 342 towards the top face of the lens 30. In one embodiment, to further facilitate light reflection, the light-reflecting face 33 may be coated with a reflective layer (such as aluminum layer or silver layer). The light-reflecting face 33 has a top edge directly connected to a light-emergent face 32 of the lens 30, and a bottom edge connected to the bottom face 31 of the lens 30.

A central area of the top face of the lens 30 is concaved downwardly to form a convex first light-emergent face 321, a flat second light-emergent face 322 surrounding the first light-emergent face 321, and a lateral face 330 connecting the convex first light-emergent face 321 and the flat second light-emergent face 322. The flat second light-emergent face 322 directly connects the top edge of the light-reflecting face 33 at an outer periphery thereof. The flat second light emergent-face 322 is located higher than the convex first light-emergent face 321. The lateral face 330 has an inner diameter gradually decreasing from the flat second light-emergent face 322 towards the convex first light-emergent face 321. The lateral face 330 has a shape like a truncated conical face. The convex first light-emergent face 321 and the flat second light-emergent face 322 cooperatively form the light-emergent face 32 of the lens 30. The convex first light-emergent face 321 mainly takes charge for the light transmitted from the first light-incident face 341 (such as the light beam b), and the flat second light-emergent face 322 mostly takes charge for the light totally reflected by the light-reflecting face 33 (such as the light beam a), to thereby refract all of the light from the LED 20 out of the lens 30 into narrow and parallel beams. That is to say, the first light-incident face 341 corresponds to the convex first light-emergent face 321, and the second light-incident face 342 corresponds to the flat second light-emergent face 322 since light from the second light-incident face 342 is first reflected by the light-reflecting face 33 and then exit through the flat second light-emergent face 322. However, there is a small part of light transferring through the first light-incident face 341 and reflected by the light-reflecting face 33 and exiting out of the lens 30 through the flat second light-emergent face 322. The lateral face 330 does not have any light passing therethrough. To ensure that light with large emergent angles from the LED 20 directly incidents on the light-reflecting face 33, the bowl shaped lens 30 has a minimum depth so that the light reflecting face 33 intersects with an imaginary line Y, wherein the imaginary line Y is defined by connecting the LED die 22 and an intersection point where boundaries of convex first light-emergent face 321 and the lateral face 330 meet. Furthermore, in order to make sure that all the light reflected by the light-reflecting face 33 passes through the flat second light-emergent face 322, a diameter of a bottom of the light-reflecting face 33 is larger than a diameter of a top of the lateral face 330.

As each part of incident light from the LED 20 being adjusted by the light-incident face 34, the light-reflecting face 33, and the light-emergent face 32, a resultant light emitted from the LED unit 100 may be effectively converged to parallel beams capable of being projected to a long distance without significant decreasing in intensity.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An light emitting diode (LED) unit, comprising:
an LED; and
a lens comprising a light incident face facing the LED, a light emergent face away from the LED, and a light reflecting face between the light incident face and the light emergent face;
the light incident face comprises a first light incident face over the LED, and a second light incident face encircling the LED; and
the light emergent face comprises a first light emergent face corresponding to the first light incident face, and a second light emergent face corresponding to the second light incident face, wherein the first light emergent face, relative to the first light incident face, is lower than the second light emergent face,
wherein light emitted through the first light incident face from the LED is refracted by the first light emergent face to first light beams, and light emitted through the second light incident face from the LED is reflected by the light reflecting face and refracted by the second light emergent face to second light beams, and the second light beams are substantially parallel to the first light beams.

2. The LED unit of claim 1, wherein the second light emergent face is a flat surface.

3. The LED unit of claim 1, wherein the first light emergent face is a convex surface and surrounded by the second light emergent face.

4. The LED unit of claim 1, wherein the first light emergent face is a flat surface.

5. The LED unit of claim 1, wherein the second light emergent face is an annular surface.

6. The LED unit of claim 1, wherein the light reflecting face is a curved surface.

7. The LED unit of claim 1, the light emergent face further comprises a lateral face, wherein the second light emergent face is connected to the first light emergent face via the lateral face.

8. The LED unit of claim 7, wherein light emitted from the first light emergent face and the second light emergent face does not pass through the lateral face.

9. The LED unit of claim 7, wherein the lateral face is cone shaped having diameters gradually decrease from the second light emergent face towards the first light emergent face.

10. The LED unit of claim 7, the light reflecting face intersects with an imaginary line, wherein the imaginary line is defined by the LED and an intersection point where boundaries of the first light emergent face and the lateral face intersect.

11. The LED unit of claim 1, wherein the light reflecting face is directly connected to the second light emergent face, and connected to the second light incident face via a bottom face of the lens.

12. The LED unit of claim 11, wherein the second light emergent face is parallel to the bottom face of the lens.

13. The LED unit of claim 1, the light reflecting face has a diameter of an edge connecting to the light incident face, the diameter is larger than a diameter of an edge of the second light emergent face connecting to the first light emergent face.

14. The LED unit of claim 1, wherein the lens defines a cavity to totally receive the LED.

15. The LED unit of claim 14, wherein the first light incident face together with the second light incident face enclose the cavity.

16. The LED unit of claim 1, wherein the lens has an optical axis extending through the LED.

17. The LED unit of claim 1 further comprising a printed circuit board supporting the LED, wherein a bottom face of the lens contacts the printed circuit board.

18. A lens comprising:
a light incident face for light entering the lens, the light incident face comprising a first light incident face, and a second light incident face extending away from a periphery of the first light incident face;
a light emergent face for refracting light out towards a central axis of the lens, the light emergent face comprising a first light emergent face corresponding to the first light incident face, and a second light emergent face corresponding to the second light incident face, wherein the first emergent face is lower than the second emergent face in relation to the light incident face; and
a light reflecting face between the light incident face and the light emergent face for refracting light towards the second light emergent face.

19. The lens of claim 18, wherein the first light incident face is circular and flat, and the second light incident face is annular and extends substantially perpendicularly from the first incident face along a direction away from the light emergent face.

20. The lends of claim 19, the light emergent face further comprises a lateral face, the first light emergent face is circular and convex, and the second light emergent face is annular and flat; wherein the lateral face interconnects between an outer edge of the first light emergent face and an inner edge of the second light emergent face, and the lateral face converges from the second light emergent face to the first light emergent face.
